(19) United States
(12) Patent Application Publication
(10) Pub. No.: US 2015/0095083 A1
(43) Pub. Date: Apr. 2, 2015

(54) METHOD, APPARATUS, AND COMPUTER READABLE MEDIA FOR MATCH RATING AND INTERVIEW SCHEDULING

(71) Applicant: NATIONAL RESIDENT MATCHING PROGRAM, WASHINGTON, DC (US)

(72) Inventors: MONA M. SIGNER, POTOMAC, MD (US); NICOLE S. NITOWSKI, VIENNA, VA (US)

(21) Appl. No.: 14/505,444

(22) Filed: Oct. 2, 2014

Related U.S. Application Data
(60) Provisional application No. 61/886,048, filed on Oct. 2, 2013.

(51) Int. Cl. G06Q 10/06

(52) U.S. Cl. CPC G06Q 10/063114
USPC 705/7.15

(57) ABSTRACT

Method, apparatus, and computer-readable media for managing training programs. An exemplary method comprises storing data associated with a plurality of training programs within at least one data structure in a database, receiving a selection of at least one training program of the plurality of training programs, tracking the at least one selected training program, managing an interview for a user corresponding to the at least one selected training program, and storing revised data associated with the at least one selected training program within the at least one data structure based at least in part on the interview.

### CROSS REFERENCE TO RELATED APPLICATION

This application claims priority to U.S. Provisional Patent Application Ser. No. 61/886,048, filed Oct. 2, 2013, which is incorporated herein by reference in its entirety.

### SUMMARY OF THE INVENTION

Some of the disclosed embodiments relate to a computer-implemented method executed by one or more computing devices for managing training programs. An exemplary method comprises storing data associated with a plurality of training programs within at least one data structure in a database, receiving a selection of at least one training program of the plurality of training programs, tracking the at least one selected training program, managing an interview for a user corresponding to the at least one selected training program, and storing revised data associated with the at least one selected training program within the at least one data structure based at least in part on the interview.

Some of the disclosed embodiments also relate to an apparatus for managing training programs. An exemplary apparatus may comprise one or more processors and one or more memories operatively coupled to at least one of the one or more processors and having instructions stored thereon that, when executed by at least one of the one or more processors, cause at least one of the one or more processors to enable the storage of data associated with a plurality of training programs within at least one data structure in a database, receive a selection of at least one training program of the plurality of training programs, track the at least one selected training program, manage an interview for a user corresponding to the at least one selected training program, and enable the storage of revised data associated with the at least one selected training program within the at least one data structure based at least in part on the interview.

Some of the disclosed embodiments further relate to at least one non-transitory computer-readable medium storing computer-readable instructions that, when executed by one or more computing devices, cause at least one of the one or more computing devices to store data associated with a plurality of training programs within at least one data structure in a database, receive a selection of at least one training program of the plurality of training programs, track the at least one selected training program, manage an interview for a user corresponding to the at least one selected training program, and store revised data associated with the at least one selected training program within the at least one data structure based at least in part on the interview.

As disclosed herein, according to aspects of the disclosed embodiments, the data may include data from at least one survey associated with ratings of training programs corresponding to a set of attributes or factors, the training programs may be residency and fellowship training programs, ratings information may be displayed associated with one or more of the plurality of training programs, ratings information corresponding to an attribute associated with the selected training program may be received, and an overall rating for the selected training program based at least in part on the ratings information may be calculated.

### BRIEF DESCRIPTION OF THE DRAWINGS

FIG. 1 illustrates an exemplary method according to aspects of the disclosed embodiments.

FIGS. 2-28 illustrate exemplary user interfaces according to aspects of the disclosed embodiments.

FIGS. 29-30 illustrate exemplary data flow and data structure manipulation according to aspects of the disclosed embodiments.

FIG. 31 illustrates an exemplary computing environment according to aspects of the disclosed embodiments.

FIG. 32 illustrates an exemplary network environment according to aspects of the disclosed embodiments.

### DETAILED DESCRIPTION OF THE INVENTION

This disclosure describes aspects of embodiments for carrying out the inventions described herein. Of course, many modifications and adaptations will be apparent to those skilled in the relevant arts in view of the following description and in view of the accompanying drawings and the appended claims. While the aspects of the disclosed embodiments described herein are provided with a certain degree of specificity, the present technique may be implemented with either greater or lesser specificity, depending on the needs of the user. Further, some of the features of the disclosed embodiments may be used to obtain an advantage without the corresponding use of other features described in the following paragraphs. As such, the present description should be considered as merely illustrative of the principles of the present technique and not in limitation thereof.

Aspects of the disclosed embodiments provide an enhanced computer-implemented method and system. The disclosed embodiments relate to a modern tool that can be used and accessed from a mobile device such as a phone or tablet and that allows applicants to residency or fellowship training programs to track and organize programs during the interview process and develop program ratings that can be used to generate a rank order list in web-based systems, such as the Registration, Ranking, and Results® (R3®) system developed by the National Resident Matching Program® (NRMP®). The disclosed embodiments make readily available a compilation of key characteristics and details about the programs, which can be obtained from any suitable source. Additionally, the disclosed embodiments provide the ability to rate programs on a series of factors drawn from one or more sources, such as surveys and the like, with the ability to create custom factors and rate those as well. The applicant can keep track of the programs to which they have applied and where they are in the interview process, and sync this information with their native device calendar.

The disclosed embodiments can be implemented as a smartphone application on the iOS and Android platforms, for example. The disclosed embodiments may be implemented using an application designed and implemented to function as a smartphone or mobile application or ‘app’ on both the iOS and Android platforms. It is downloaded from Apple App Store or from Google Play to the user's device.

Historically, applicants to residency and fellowship training programs, such as medical residency and fellowship training programs, have had to generate their own methods and strategies for tracking interviews with and impressions about those programs, and then organize those programs in order of preference. Because applicants routinely apply to dozens of programs and participate in many interviews, methods and strategies previously utilized by applicants could be labor-intensive, time-consuming, and disorganized.

In contrast, aspects of the disclosed embodiments provide applicants with a single, uniform environment in which to manage the interview and matching process. As described herein, the disclosed embodiments may be portable and accessible from any computing device, such as a mobile device, once downloaded as a non-transitory computer-readable medium, for example. Some of the disclosed embodiments may utilize data such as current program directory information and details, as well as several data points which may be specific to and only available from a designated service.

The disclosed embodiments can be utilized to assist applicants while they are applying to residency and fellowship training programs and creating rank order lists of programs that are used by, or registered with, a designated matching service that processes a matching algorithm to place applicants in medical residency and fellowship training programs. Large numbers (i.e. tens of thousands annually) of applicants apply to medical residency and fellowship training programs that participate in matching services. Those programs need to be evaluated by applicants during the interview process so each program can be effectively ranked in comparison to others at which the applicant interviews. The disclosed embodiments can be utilized to complete this process simply and more efficiently by applicants for training programs, for example, medical residency and fellowship training program applicants.

The disclosed embodiments further provide a way to help applicants who participate in matching programs to keep track of interviews and rate programs. For example, applicants participating in matching programs may be periodically queried or surveyed regarding factors they consider to be important when selecting programs with which to interview and rank. Some embodiments utilize those factors to help applicants identify suitable training programs and input custom ratings for any training programs with which they interview or otherwise interact. These features can help applicants determine which training programs may be best suited to provide the training they desire.

The data used by the disclosed embodiments can be stored in any suitable storage, and may include, for example, characteristics and data about residency and fellowship training programs, and can be refreshed on a periodic basis. Additionally, information associated with ratings for medical residency training programs can be acquired from applicant surveys that are conducted periodically, or from any other source.

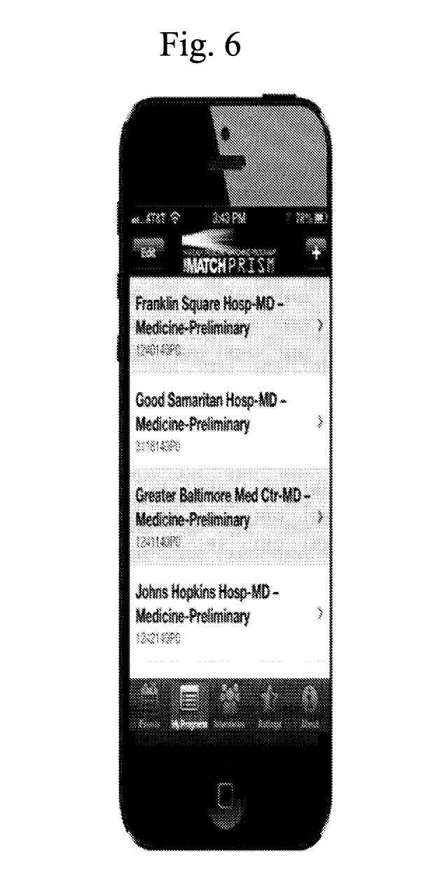

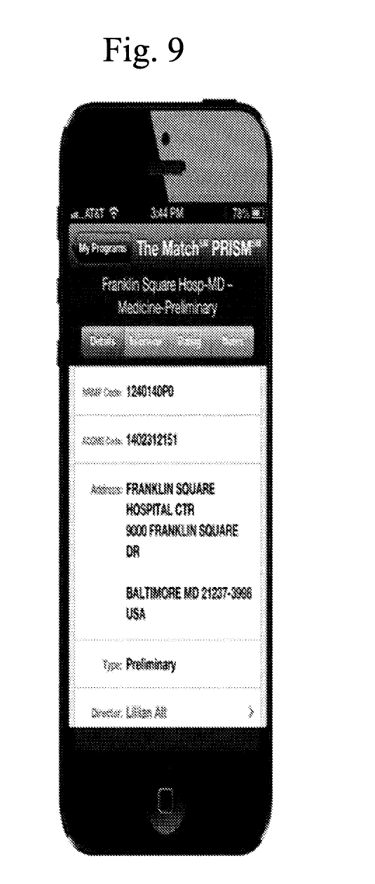

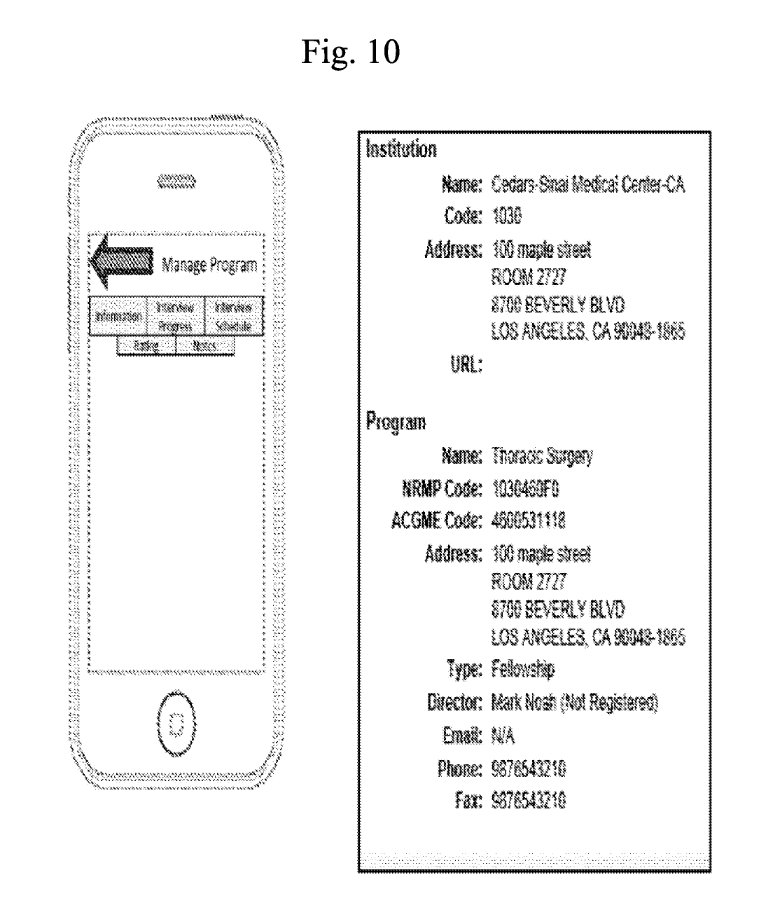

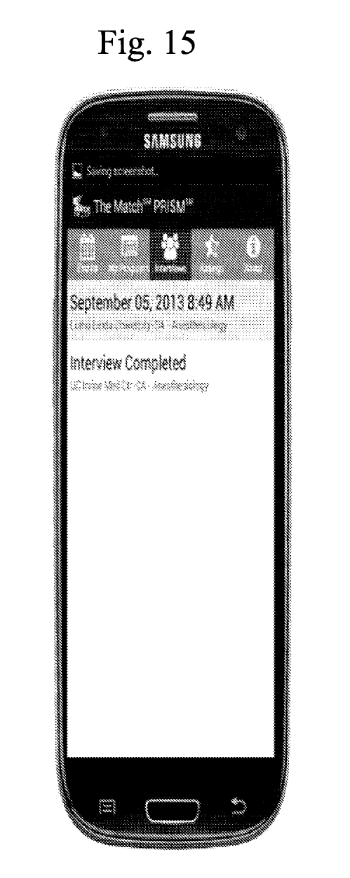

The systems of the disclosed embodiments may comprise a listing of key dates in the residency matching process, a database of data for residency and fellowship training programs which participate in the matching process; a user interface which allows a user to select, view, and/or organize any training programs under consideration, and a separate user interface which allows a user to schedule, manage, and track interviews for residency or fellowship training programs under consideration. For example, FIG. 6 illustrates the “My Programs” screen which allows a user to select programs for tracking on the system of the disclosed embodiments. See also FIG. 15 which illustrates the “My Interviews” screen which allows a user to track previous and upcoming scheduled interviews with particular residency or fellowship training programs. FIGS. 9 and 10 illustrate examples of “Manage My Programs” screens which allows a user to view information about a selected residency or fellowship training program, view ratings information, view the status of the interview process (the “Interview Progress”), and view an interview schedule, if applicable, for the residency or fellowship training program managed on this screen. The user also can input the interview date and time and change the interview date and time, if necessary. The system will place the date and time of the interview on the user's calendar included in the device. Status data for the interview also may be displayed. For example, if an interview is scheduled, the system will reflect the “interview scheduled” state. If the date of the interview is past, the system will reflect the “interview completed” state.

The system may further comprise a third user interface which allows a user to input ratings for different features of the programs with which the user has interviewed. For example, in some embodiments, a user may select ratings for factors or attributes of the residency or fellowship training programs under consideration. Factors for rating the residency or fellowship training programs may include, for example and without limitation, an overall rating, whether the program is part of an academic medical center, the career paths of recent graduates from the training program, the cost of living for the locale of the training program, the diversity of patient problems treated in that particular medical center, and an appropriate balance between faculty supervision and resident responsibility for patient care. A user further has the option to select and add additional criteria to include in the rating of a training program. In this regard, additional criteria may also be created based on user inputs, and those criteria may be included in the rating of a training program. The system will calculate the overall rating for each residency or fellowship training program based on an average of the ratings input by the user for each factor rated and, at the user's request, sort the training programs by overall rating. The average rating is calculated across only those factors which have a rating. If a factor is kept at “off” in the system, the factor may not be included when the overall rating is calculated. While each criterion or factor is typically given equal weight when the overall rating is calculated, one or more of the criteria or factors may be weighted based, for example, on user preferences. In a further embodiment, a user may be able to add freestyle typed notes regarding the user's impression or thoughts about a particular residency or fellowship training program under consideration. The system will then generate a report of all programs, ordered by overall rating, which the user can export from the system via e-mail, Skype, or other similar process. The report may then be used by a user to generate a rank order list of preferred residency or fellowship training programs in a designated matching service, which in turn may be used to match other user applicants with residency or fellowship training programs.

In some embodiments, ratings data for various attributes or factors of participating residency or fellowship training programs may be stored in a database. The ratings data may be obtained as a result of surveys of past residency program applicants conducted after those applicants submit rank order lists of selected residency training programs to a designated matching service. For example, when the user selects a training program and factors to be evaluated, an application programming interface (API) may be used to execute an SQL query, which may include a call to a SQL function. The SQL function can use the survey results stored in the database to create a temporary database table within a database or data structure which may include, for the selected residency and fellowship programs, the ratings for each factor in the selected programs.

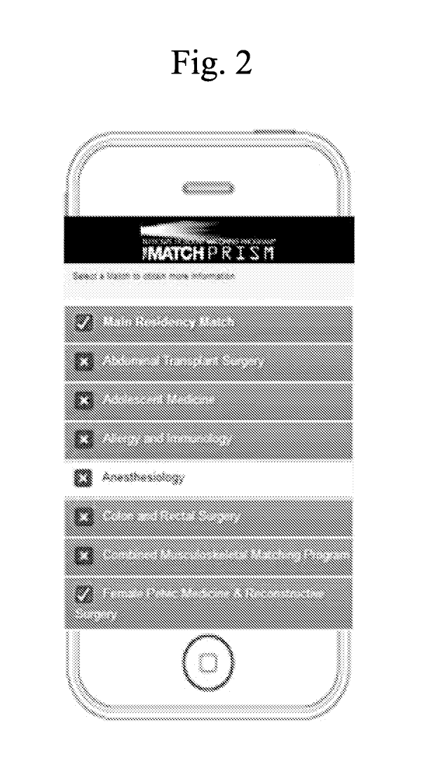

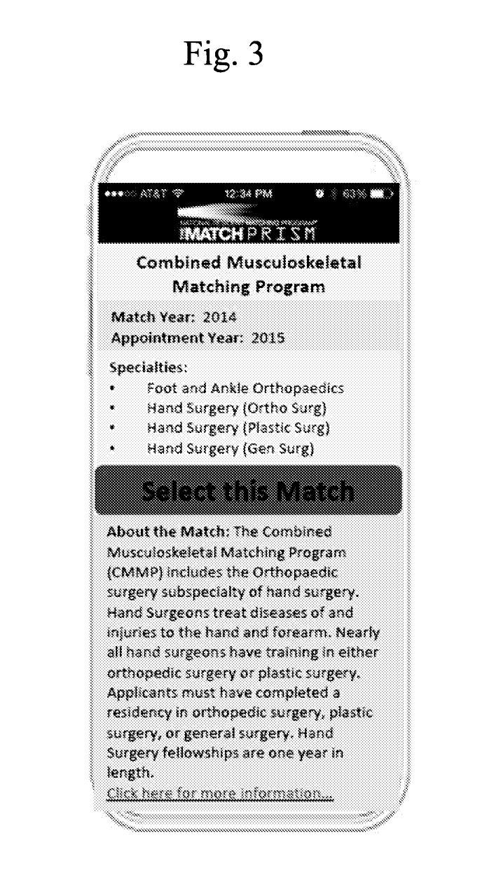

Some embodiments of the system may further allow a user to select the particular Match program to be loaded onto the device. For example, the Main Residency Match® program or one of a variety of fellowship matching programs may be selected. See FIGS. 2-3 which illustrate the Match Screen or List of Match Programs and which provide information about different residency or fellowship training programs available to the user. In FIG. 2, a user may select a Match to obtain more information about that Match. When responding to user inputs and selections, algorithms may be executed as set forth below:

Show all Matches in extracts that exist in Join between MATCH and MATCH_TYPE_SPECIALTY and MATCH_EVENTS based on MATCH_ID.

If SHOW_MATCH_IND=‘Y’ then show with green check or other icon indicating it may be set as the current Match for the disclosed embodiments.

If SHOW_MATCH_IND=‘N’ then show with red X or other icon indicating that it is not available for right now.

Regardless of SHOW_MATCH_IND—when the user selects a Match record, move on to About Match screen FIG. 3.

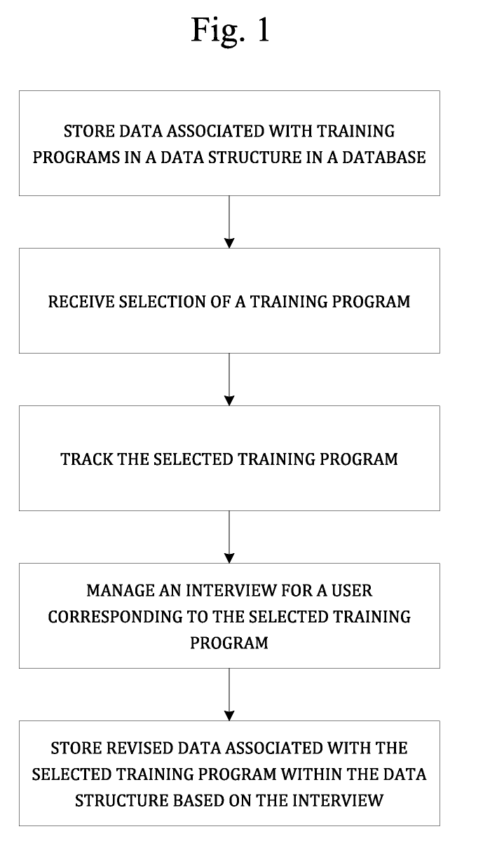

As illustrated in FIG. 1, methods according to some embodiments may comprise building a database of data for residency and fellowship training programs which participate in the matching process, wherein the database includes ratings of training programs based on survey-driven program attributes or factors; selecting residency training programs under consideration for tracking in the disclosed embodiment; and managing interviews for residency training programs under consideration. Methods according to some embodiments may further comprise tracking. See FIG. 15 which illustrates the “My Interviews” screen. Methods according to some embodiments may further comprise viewing general information about selected residency or fellowship training programs, viewing ratings information for selected residency or fellowship training programs, and viewing the status of the interview process for those residency or fellowship training programs. FIG. 9 illustrates an example of a “Manage My Programs” screen in the disclosed embodiments.

In some embodiments, methods may further comprise rating attributes or factors of the residency or fellowship training programs under consideration; calculating an overall rating for each residency or fellowship training program based on an average of the rating assigned to each attribute or factor considered by the user. Upon user request, methods may further comprise sorting the residency training programs by overall rating. In some embodiments, methods may further comprise generating a report of the programs rated, for example, by overall rating score, which the user can export from the system via e-mail, Skype, or other similar process. The data in this report may also be transmitted to a server or other device for further processing.

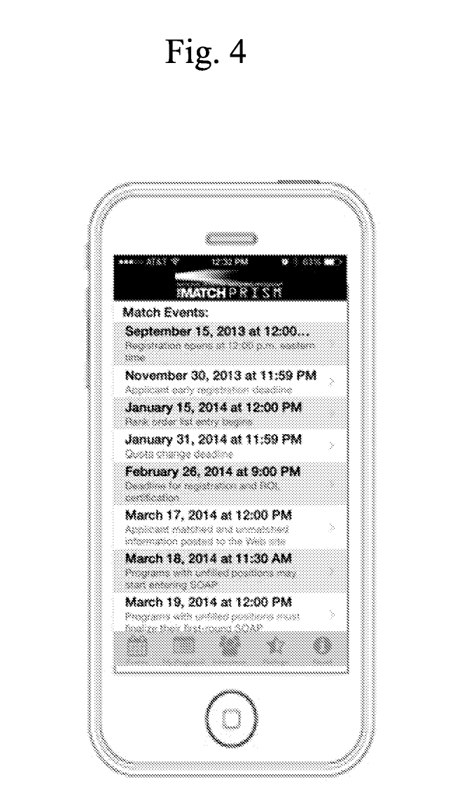

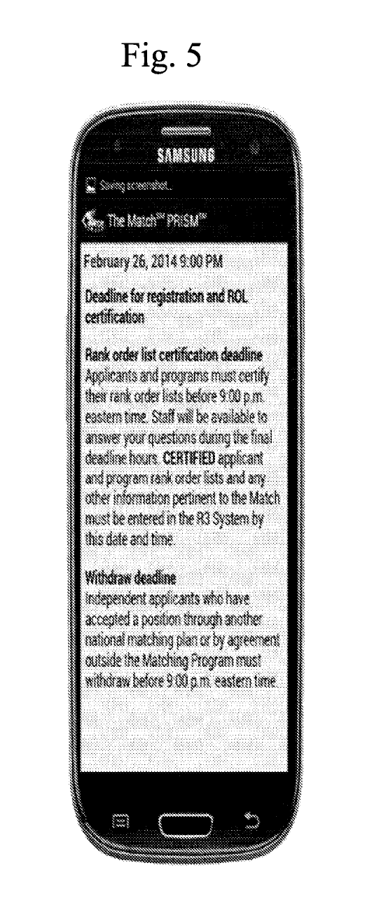

Methods of the some embodiments may further comprise listing the key dates in the residency or fellowship matching process for the user to review. For example, FIG. 4 shows the “Home Screen” according to some embodiments. FIG. 4 also displays a list of Match Events for the Match under consideration. When a user clicks on a list record, the system will display a verbose description of the Event. (See FIG. 5) Selector buttons for navigation on the Home Screen as shown in FIG. 4 may include “Home,” “My Programs,” “My Interviews,” “Ratings Report” and other similar buttons. The Home Screen displays Match Events for the Match using data for the selected match process from the Match Events extract. The screen displays each event's Date and Time in bold, followed by Description text below, in order by date and time. In some embodiments, fellowship Matches all have the same Events. The Main Residency Match has additional Events. When a user clicks an Event, a further interface may be displayed including additional information about the Event. The screen may include five selector buttons for menu navigation: Home, My Programs, Interviews, Ratings, and About.

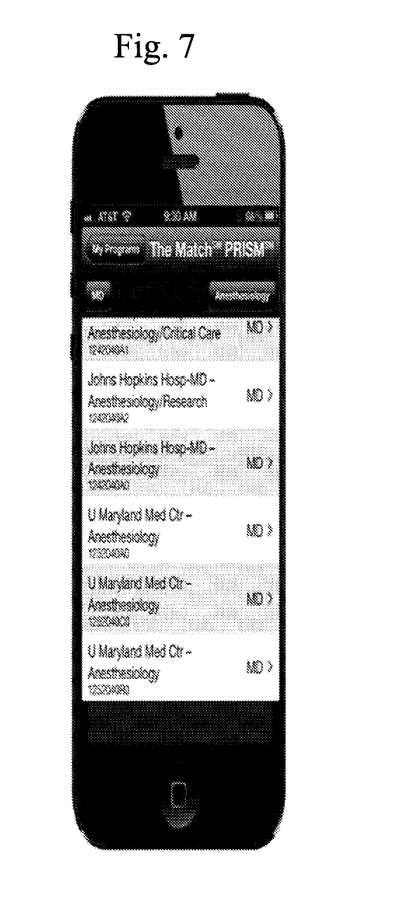

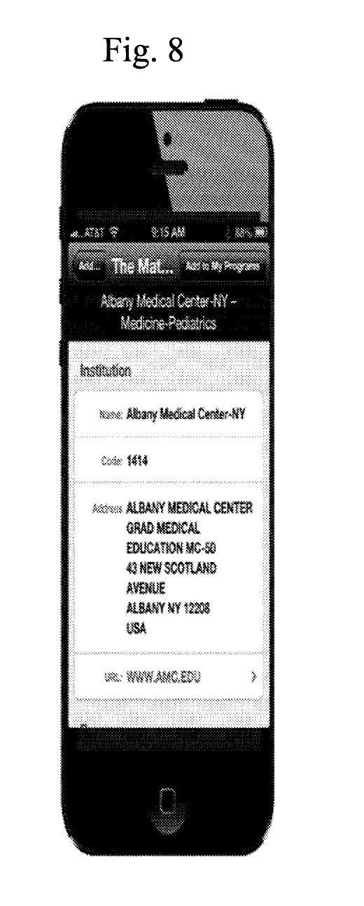

FIG. 6 illustrates the “My Programs” screen for the disclosed embodiments. The interface shown in FIG. 6 allows a user to select programs to be tracked in the system. A user can select a “+” or similar icon to “add a program” for tracking. Selecting the “+” or similar icon will allow the user to navigate to a “search and add” sub screen for example (FIGS. 7 and 8). The user will be able to search through a list of residency or fellowship training programs and select one or more programs to add directly to the user's system in the disclosed embodiments. The search results may be returned in a list including, for example, the name of the medical institution, the name of the medical specialty, and the discrete program code affiliated with the designated matching service. Selecting or clicking on a particular program at this screen will also navigate the user back to the Information screen of FIG. 10 which will be further discussed below. The selected programs will be visibly listed on the “My Programs” screen as shown in FIG. 6. The user will also have the ability to delete selected programs through a left-to-right swipe on the selected program, if desired.

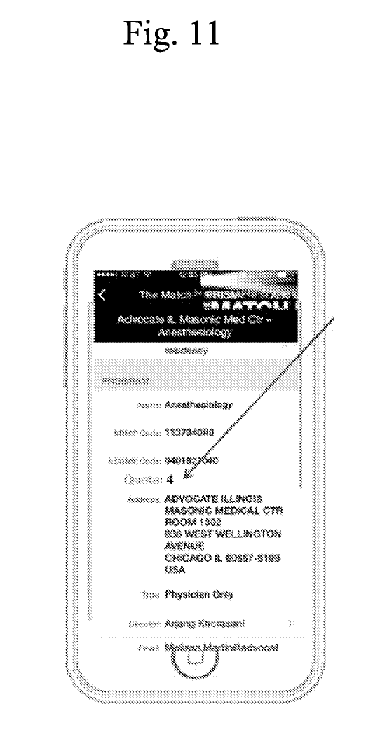

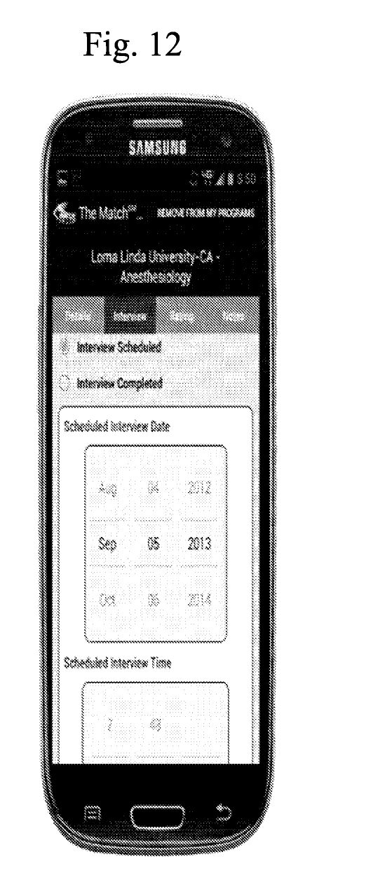

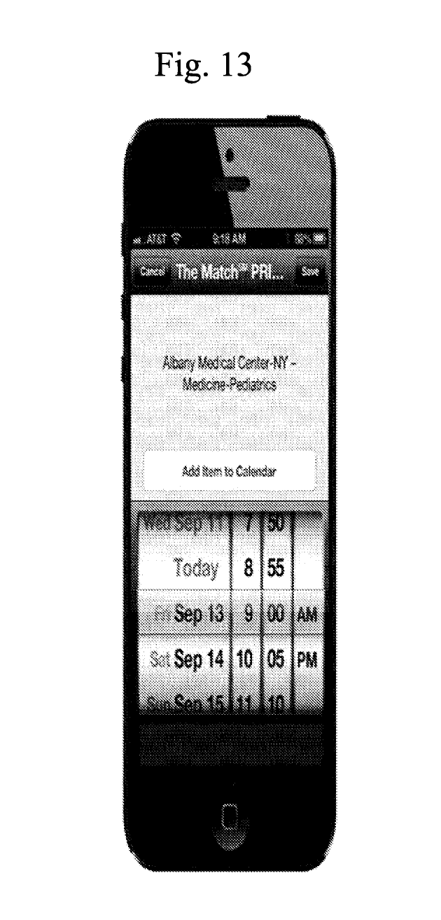

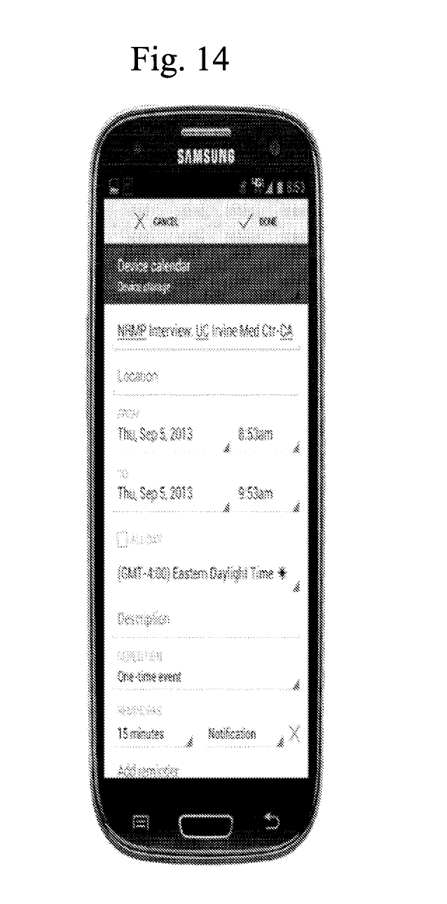

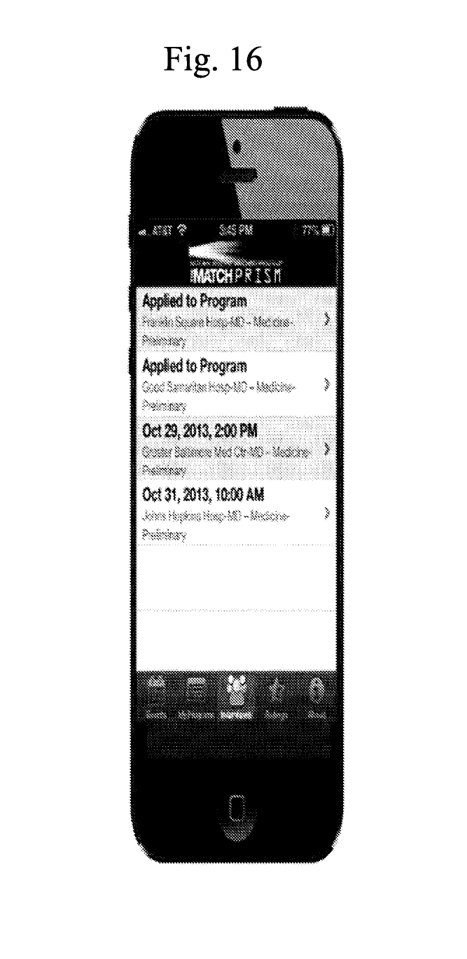

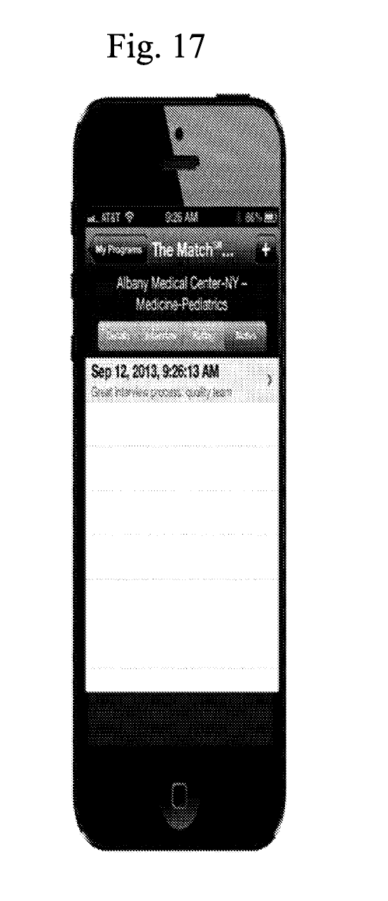

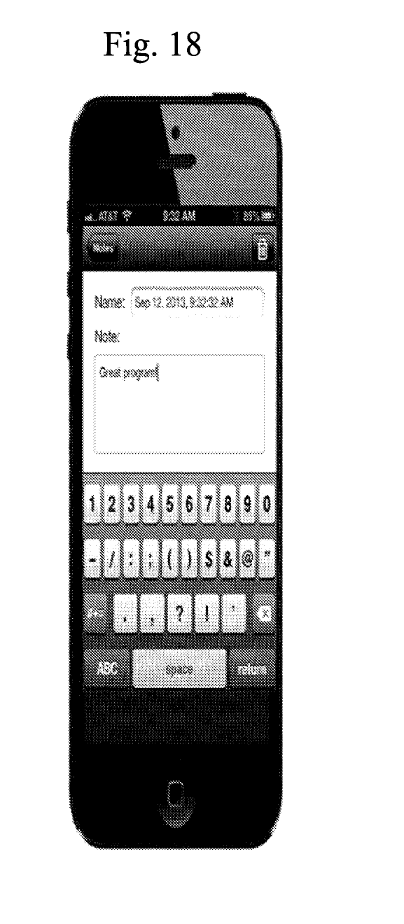

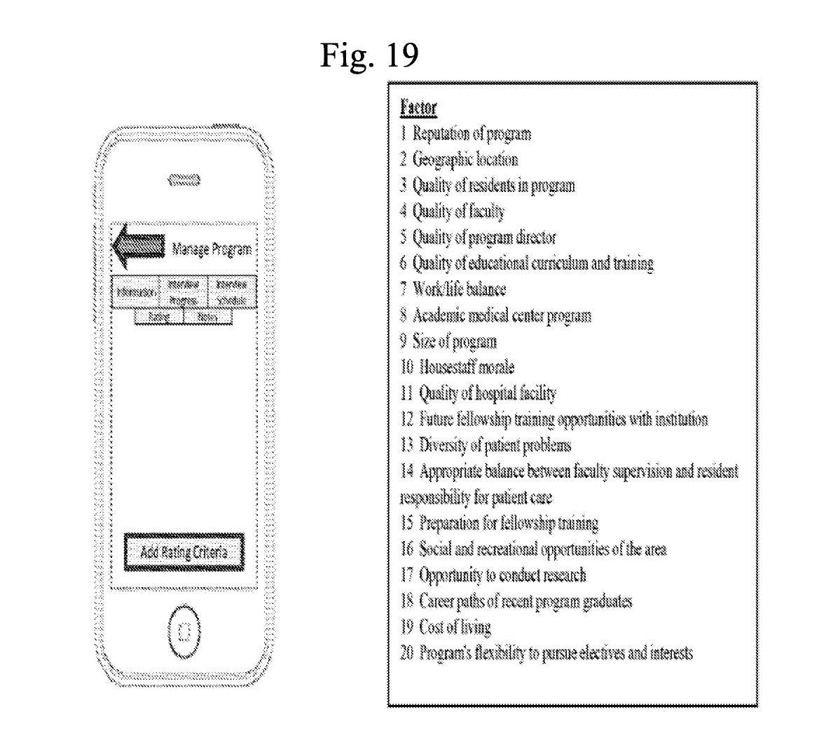

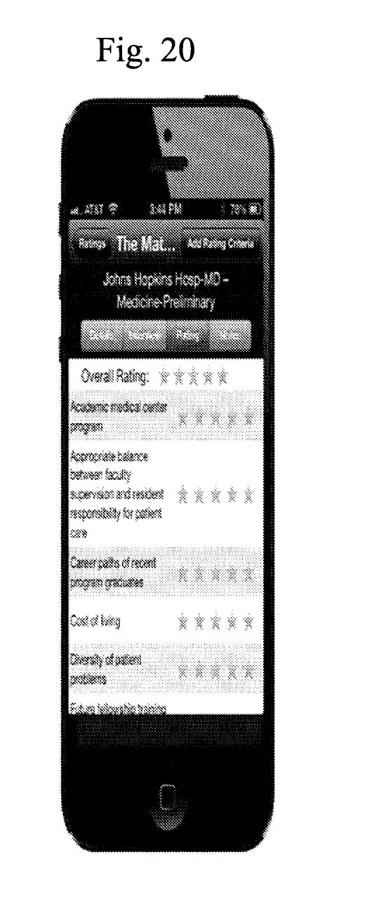

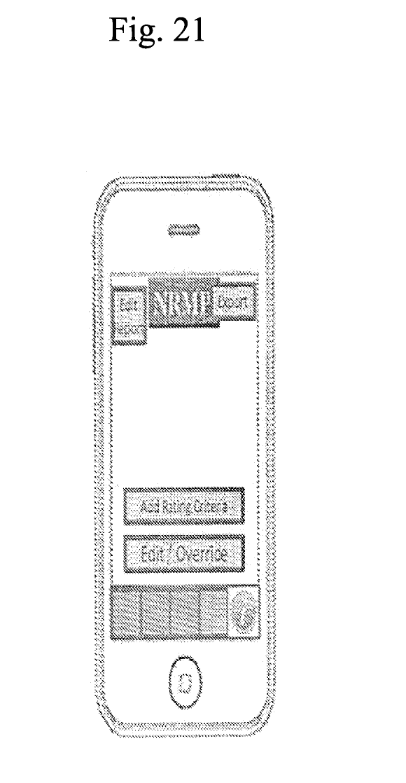

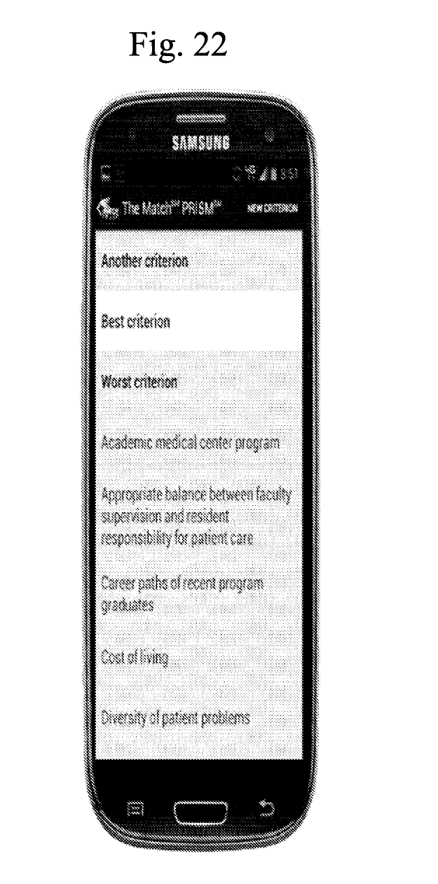

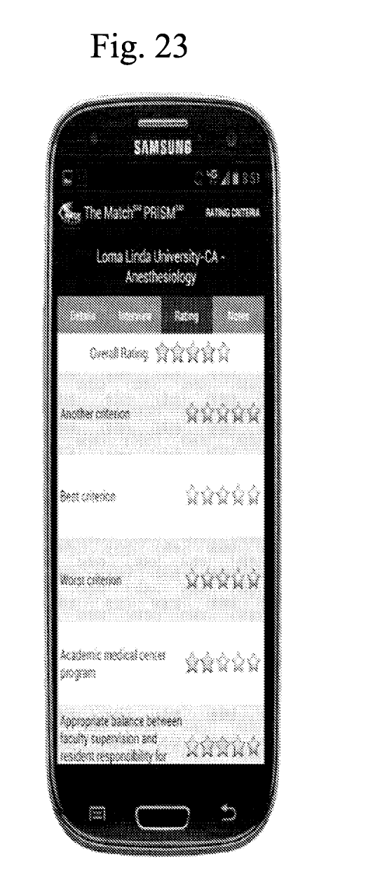

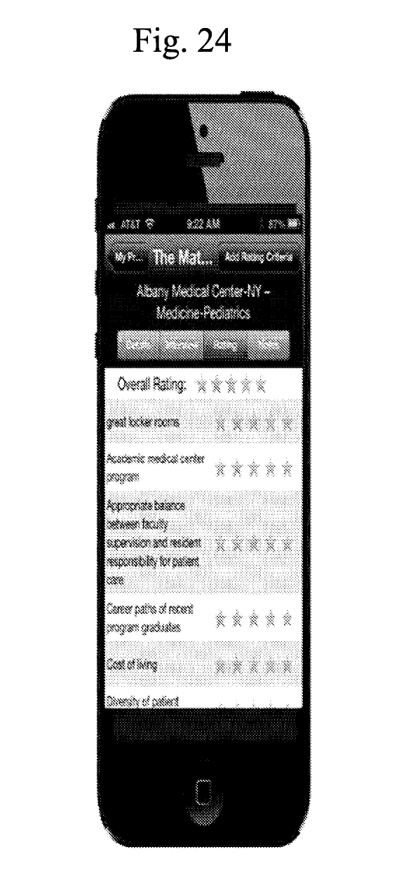

When a user then selects a program on the “My Program” screen in FIG. 6, the system will navigate the user to the “Manage My Programs” screen. See FIGS. 9 and 10. In the disclosed embodiment, the “Manage My Programs” screen may include selector buttons such as “Information,” “Interview Progress,” “Interview Schedule,” “Ratings,” and “Notes,” for example and without limitation. The “Information” button in FIG. 10 may include, for example, contact information and other general information for the selected residency or fellowship training program. See also FIG. 11. When the “Interview Progress” or similar button is selected, the system may display a radio button list showing the current state of the interview process for the program that is being managed. The radio button list may include selections such as “applied to program,” “no interview,” “interview scheduled,” and “interview complete”, for example. See FIG. 12. Alternatively, the “Interview Progress” button as shown in FIG. 10 could have the current status identified at the top of the screen with a “change status” button nearby to allow the user to change the interview status if necessary. When the “Interview Schedule” button is selected, the system will display the scheduled interview date and time for that selected program via a sub screen. See FIGS. 12 and 13. A user may also change the interview date and time if desired at this sub screen. The interview date and time can also be added to a user's calendar on the device if desired as shown on FIG. 14. FIG. 15 shows a user's upcoming scheduled interview and another completed interview at a different residency training program. FIG. 16 is another example of a user's schedule for selected residency training programs which includes programs where the user has “applied to program” or where interviews have been scheduled and remain pending. When the “Rating” button is selected (See FIGS. 19 and 20), the overall ratings score for that particular program is shown at the top of the screen. The screen will further display a list of program attributes or factors with a selector bar or similar tool to indicate, on a scale of 1 to 5, how important each attribute or factor is to the user's consideration of the selected program. The overall rating score may then be calculated based on an average of those factors which have a score. As described above, if a factor is not rated, it will be not calculated into the overall rating. In FIGS. 21, 22, 23, and 24, a user may also add additional rating criteria to be figured into the overall ratings score if desired. A user can also enter the user's own notes on the “Manage My Programs” screen in FIG. 17. The user can select the “Notes” button and the system will navigate the user to the notes screen. The “Notes” screen will list the notes and the date they were added or posted. In FIG. 18, a user can edit a note by selecting the note, entering any new text, and saving the revised note. The sub-screen in FIG. 18 is needed to enter the text and also may include in some embodiments a return button “Notes” to return to the “Notes” screen and a Save button. An edit button further allows deletion of typed text.

FIG. 15 illustrates the “My Interviews” screen. From this screen, a user can view dates, in calendar order, for interviews that have been scheduled within a system of the disclosed embodiments. Clicking on a scheduled interview from this screen can also navigate the user back to the “My Programs” screen of FIG. 6, as discussed above.

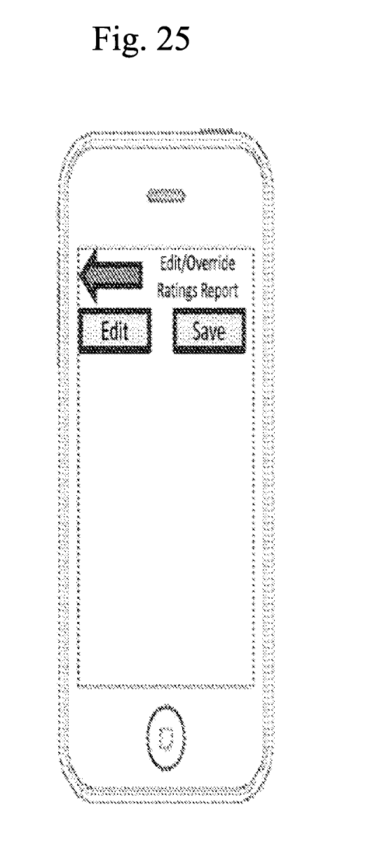

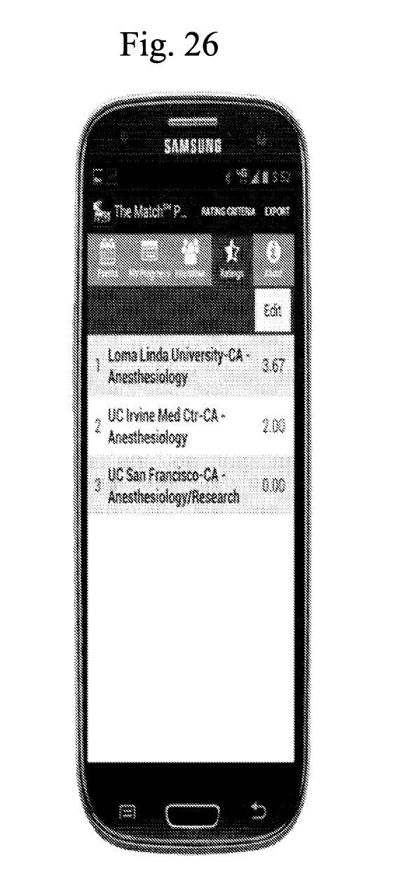

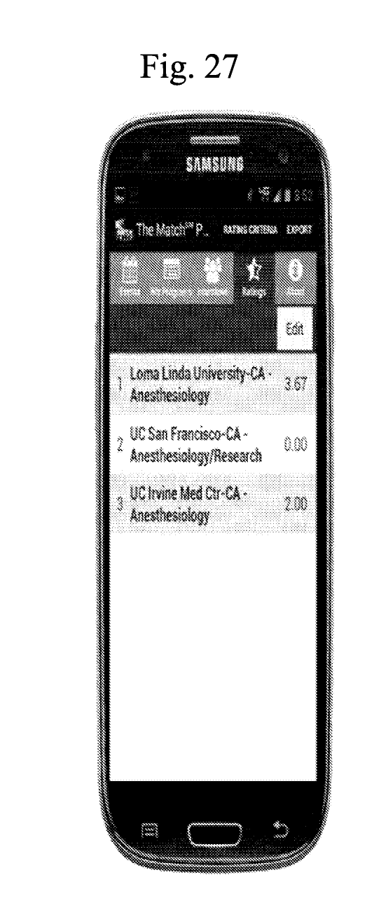

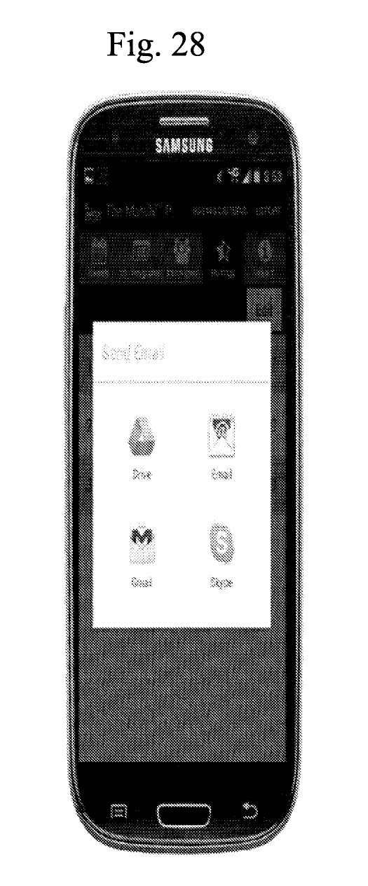

FIG. 27 displays the “Ratings Sorted List Report” screen and FIG. 26 displays the “Ratings Screen.” The disclosed embodiments may include a standard list of approximately twenty (20) attributes or factors for rating residency or fellowship training programs being considered by the user. A user may also further add the user's own criteria. The “Ratings Sorted List Report” screen shows the programs from “My Programs” in FIG. 6 that have been rated or otherwise have a score. The ratings list may be shown in order of the cumulative average score that has been calculated with the total score for the selected program also visible. A user may manually change the order of the programs here if desired or view or add additional ratings criteria if desired. (See FIGS. 19-25). As shown in FIG. 28, a user may also export this ratings list to another system or platform by selecting an e-mail button. The system will then generate an e-mail prompt with the ratings report attached to it and allow the user to input the desired recipient.

In alternate embodiments, the system may allow a user to generate a report of their rated programs that optionally can be exported directly to other computing devices, servers, or web-based systems, such as the Registration, Ranking, and Results® (R3®) system developed by the National Resident Matching Program (NRMP), to assist with the matching process for the designated matching program. If a user selects this option for direct export of the report, the system may require a user authentication, for example, using a username and password or other authentication method. The user will then further have the ability to re-direct to the web-based system on the user's mobile device, view the ranking function in the web-based system from the mobile device, and certify the ranking list in the web-based system.

In a further embodiment, the disclosed system will provide real-time data updates as residency or fellowship training programs update their directory information and status in a centralized web-based system. Users will have the option to upgrade to this option in-app and receive regular updates regarding residency or fellowship training program information. Users may be required to authenticate with the web-based system prior to using this feature and obtaining the new data updates.

In some embodiments, users may be able to launch data from other publications and resources to gather additional information regarding specific training programs and specialty training programs.

In some embodiments, the system may provide users with a recommendation based on an analytic model that identifies residency or fellowship training programs which may be the best fit for that user after an analysis of the user's past experiences. For example, such a recommendation may be based on the user's interview schedule at selected programs, factors the user identifies as being important in selecting a residency training program, and the like.

Implementations of the Disclosed Embodiment

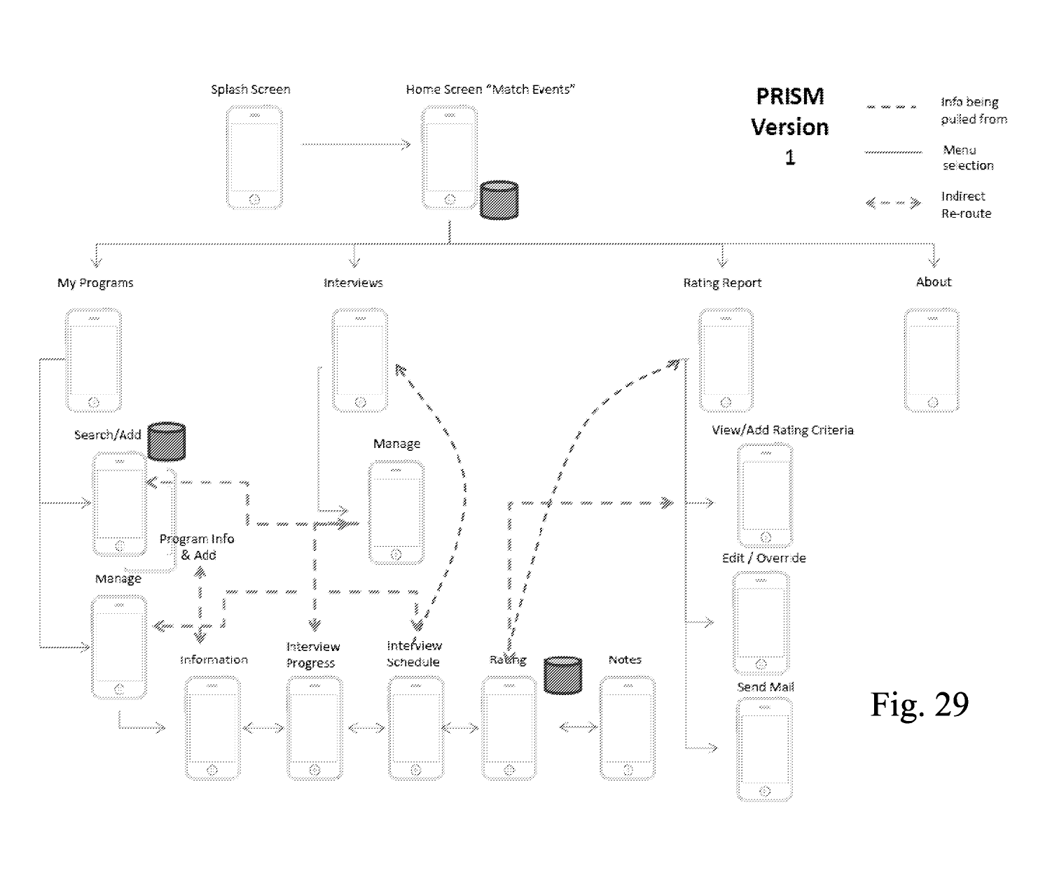

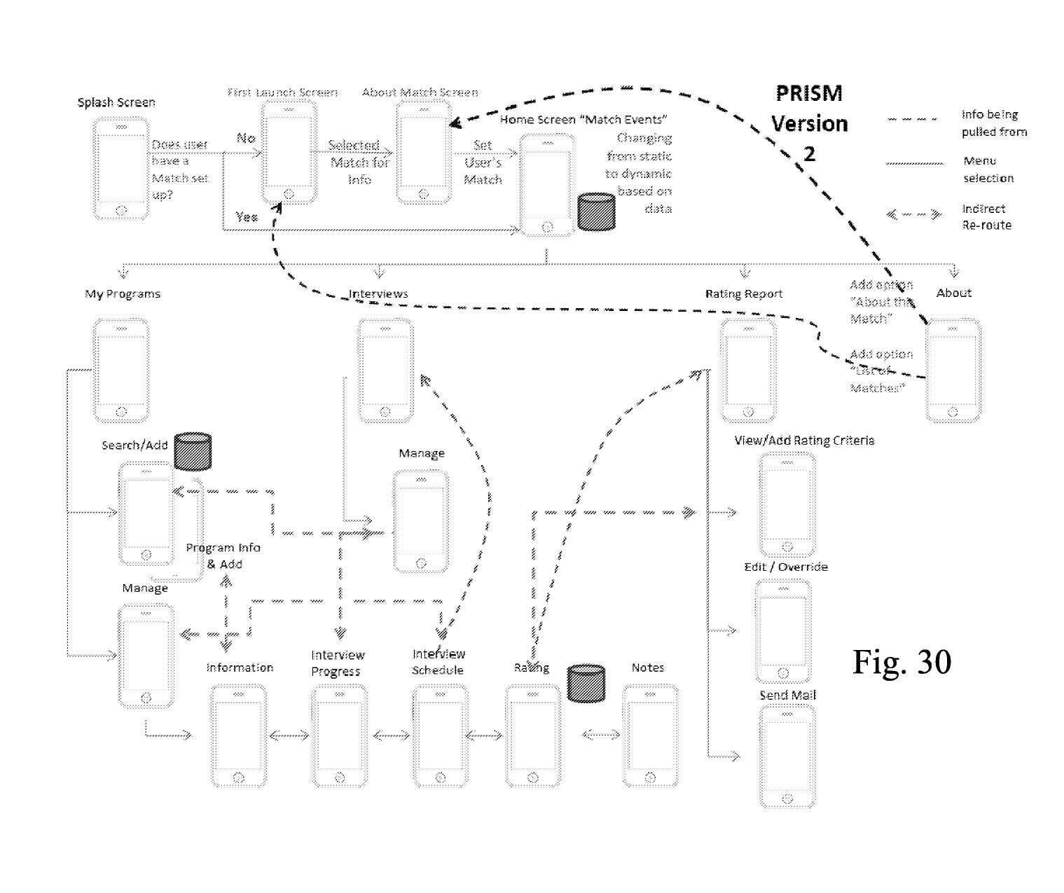

As described herein, the disclosed embodiments enable a variety of data structures and workflows for managing training programs. FIGS. 29 and 30 illustrate how data moves within the data structures of some of the disclosed embodiments and how computing devices can manipulate and store the data within data structures. FIGS. 29 and 30 also provide exemplary correlations between the movement of data within the data structures and systems of some of the disclosed embodiments and the user interfaces described herein and illustrated in other figures.

The disclosed embodiments may be implemented using an enhanced computer-implemented method executed by one or more computing devices, with steps of the method being executed by at least one of the one or more computing devices.

In addition, the disclosed embodiments may be implemented by an apparatus that preferably comprises one or more processors and one or more memories operatively coupled to at least one of the one or more processors and having instructions stored thereon that, when executed by at least one of the one or more processors, cause at least one of the one or more processors to execute the steps of the disclosed embodiments.

Furthermore, the disclosed embodiments may be implemented using computer-readable instructions stored on at least one non-transitory computer-readable medium such that the computer-readable instructions, when executed by one or more computing devices, cause at least one of the one or more computing devices to execute the steps of the disclosed embodiments.

Exemplary Computing Environment

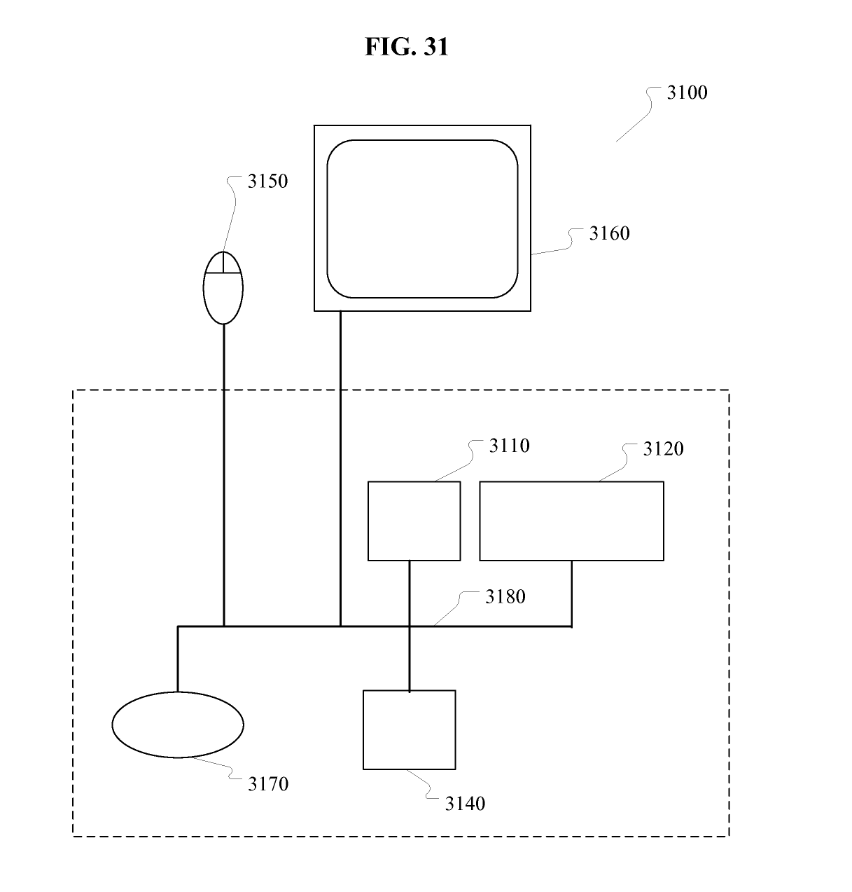

One or more of the above-described techniques can be implemented in or involve one or more computer systems. FIG. 31 illustrates a generalized example of a computing environment 3100 that may be employed in implementing the embodiments of the invention. The computing environment 3100 is not intended to suggest any limitation as to scope of use or functionality of described embodiments.

With reference to FIG. 31, the computing environment 3100 includes at least one processing unit 3110 and memory 3120. The processing unit 3110 executes computer-executable instructions and may be a real or a virtual processor. The processing unit 3110 may include one or more of: a single-core CPU (central processing unit), a multi-core CPU, a single-core GPU (graphics processing unit), a multi-core GPU, a single-core APU (accelerated processing unit, combining CPU and GPU features) or a multi-core APU. When implementing embodiments of the invention using a multi-processing system, multiple processing units can execute computer-executable instructions to increase processing power. The memory 3120 may be volatile memory (e.g., registers, cache, RAM), non-volatile memory (e.g., ROM, EEPROM, flash memory, etc.), or some combination of the two. In some embodiments, the memory 3120 stores software instructions implementing the techniques described herein. The memory 3120 may also store data operated upon or modified by the techniques described herein.

A computing environment may have additional features. For example, the computing environment 3100 includes storage 3140, one or more input devices 3150, one or more output devices 3160, and one or more communication connections 3170. An interconnection mechanism 3180, such as a bus, controller, or network interconnects the components of the computing environment 3100. Typically, operating system software (not shown) provides an operating environment for other software executing in the computing environment 3100, and coordinates activities of the components of the computing environment 3100.

The storage 3140 may be removable or non-removable, and may include magnetic disks, magnetic tapes or cassettes, CD-ROMs, CD-RWs, DVDs, or any other medium which can be used to store information and which can be accessed within the computing environment 3100. In some embodiments, the storage 3140 stores instructions for software.

The input device(s) 3150 may be a touch input device such as a keyboard, mouse, pen, trackball, touch screen, or game controller, a voice input device, a scanning device, a digital camera, or another device that provides input to the computing environment 3100. The input device 3150 may also be incorporated into output device 3160, e.g., as a touch screen. The output device(s) 3160 may be a display, printer, speaker, or another device that provides output from the computing environment 3100.

The communication connection(s) 3170 enable communication with another computing entity. Communication may employ wired or wireless techniques implemented with an electrical, optical, RF, NFC, Wi-Fi, infrared, acoustic, or other carrier.

Implementations can be described in the general context of computer-readable media. Computer-readable media are any available storage media that can be accessed within a computing environment. By way of example, and not limitation, within the computing environment 3100, computer-readable media may include memory 3120 or storage 3140.

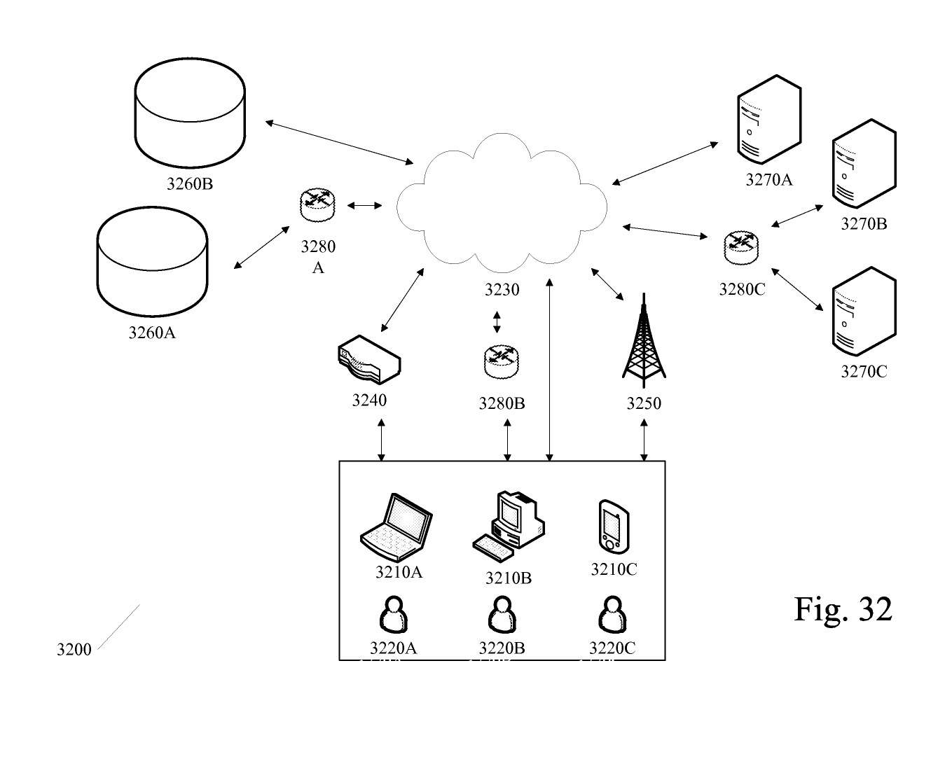

One or more of the above-described techniques can be implemented in or involve one or more computer networks. FIG. 32 illustrates a generalized example of a network environment 3200 with the arrows indicating possible directions of data flow. The network environment 3200 is not intended to suggest any limitation as to scope of use or functionality of described embodiments, and any suitable network environment may be utilized during implementation of the described embodiments or their equivalents.

With reference to FIG. 32, the network environment 3200 includes one or more client computing devices, such as laptop 3210A, desktop computing device 3210B, and mobile device 3210C. Each of the client computing devices can be operated by a user, such as users 3220A, 3220B, and 3220C. Any type of client computing device may be included.

The network environment 3200 can include one or more server computing devices, such as 3270A, 3270B, and 3270C. The server computing devices can be traditional servers or may be implemented using any suitable computing device. In some scenarios, one or more client computing devices may functions as server computing devices.

Network 3230 can be a wireless network, local area network, or wide area network, such as the internet. The client computing devices and server computing devices can be connected to the network 3230 through a physical connection or through a wireless connection, such as via a wireless router 3240 or through a cellular or mobile connection 3250. Any suitable network connections may be used.

One or more storage devices can also be connected to the network, such as storage devices 3260A and 3260B. The storage devices may be server-side or client-side, and may be configured as needed during implementation of the disclosed embodiments. Furthermore, the storage devices may be integral with or otherwise in communication with the one or more of the client computing devices or server computing devices. Furthermore, the network environment 3200 can include one or more switches or routers disposed between the other components, such as 3280A, 3280B, and 3280C.

In addition to the devices described herein, network 3230 can include any number of software, hardware, computing, and network components. Additionally, each of the client computing devices, 3210, 3220, and 3230, storage devices 3260A and 3260B, and server computing devices 3270A, 3270B, and 3270C can in turn include any number of software, hardware, computing, and network components. These components can include, for example, operating systems, applications, network interfaces, input and output interfaces, processors, controllers, memories for storing instructions, memories for storing data, and the like.

Having described and illustrated the principles of the invention with reference to described embodiments, it will be recognized that the described embodiments can be modified in arrangement and detail without departing from such principles. It should be understood that the aspects of the embodiments described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa, where appropriate and as understood by those skilled in the art.

As will be appreciated by those of ordinary skill in the art, the foregoing examples of systems, apparatus, and methods may be implemented by suitable program code on a processor-based system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such program code, as will be appreciated by those of ordinary skill in the art, may be stored or adapted for storage in one or more non-transitory, tangible machine readable media, such as on memory chips, local or remote hard disks, optical disks or other media, which may be accessed by a processor-based system to execute the stored program code.

The description herein is presented to enable a person of ordinary skill in the art to make and use the invention. Various modifications to the disclosed embodiments will be readily apparent to those skilled in the art and the generic principles of the disclosed embodiments may be applied to other embodiments, and some features of the disclosed embodiments may be used without the corresponding use of other features. Accordingly, the embodiments described herein should not be limited as disclosed, but should instead be accorded the widest scope consistent with the principles and features described herein.

What is claimed is:

1. A computer-implemented method executed by one or more computing devices for managing training programs, the method comprising:
storing, by at least one of the one or more computing devices, data associated with a plurality of training programs within at least one data structure in a database;
receiving, by at least one of the one or more computing devices, a selection of at least one training program of the plurality of training programs;
tracking, by at least one of the one or more computing devices, the at least one selected training program;
managing, by at least one of the one or more computing devices, an interview for a user corresponding to the at least one selected training program; and
storing, by at least one of the one or more computing devices, revised data associated with the at least one selected training program within the at least one data structure based at least in part on the interview.

2. The method of claim 1, wherein the data includes data from at least one survey associated with ratings of training programs corresponding to a set of attributes or factors.

3. The method of claim 1, wherein the training programs are residency and fellowship training programs.

4. The method of claim 1, further comprising displaying ratings information associated with one or more of the plurality of training programs.

5. The method of claim 1, further comprising receiving ratings information corresponding to an attribute associated with the selected training program.

6. The method of claim 5, further comprising calculating an overall rating for the selected training program based at least in part on the ratings information.

7. An apparatus for managing training programs, the apparatus comprising:
one or more processors; and
one or more memories operatively coupled to at least one of the one or more processors and having instructions stored thereon that, when executed by at least one of the one or more processors, cause at least one of the one or more processors to:
enable the storage of data associated with a plurality of training programs within at least one data structure in a database;
receive a selection of at least one training program of the plurality of training programs;
track the at least one selected training program;
manage an interview for a user corresponding to the at least one selected training program; and
enable the storage of revised data associated with the at least one selected training program within the at least one data structure based at least in part on the interview.

8. The apparatus of claim 7, wherein the data includes data from at least one survey associated with ratings of training programs corresponding to a set of attributes or factors.

9. The apparatus of claim 7, wherein the training programs are residency and fellowship training programs.

10. The apparatus of claim 7, wherein at least one of the one or more memories has further instructions stored thereon that, when executed by at least one of the one or more processors, cause at least one of the one or more processors to display ratings information associated with one or more of the plurality of training programs.

11. The apparatus of claim 7, wherein at least one of the one or more memories has further instructions stored thereon that, when executed by at least one of the one or more processors, cause at least one of the one or more processors to enable the receipt of ratings information corresponding to an attribute associated with the selected training program.

12. The apparatus of claim 11, wherein at least one of the one or more memories has further instructions stored thereon that, when executed by at least one of the one or more processors, cause at least one of the one or more processors to calculate an overall rating for the selected training program based at least in part on the ratings information.

13. At least one non-transitory computer-readable medium storing computer-readable instructions that, when executed by one or more computing devices, cause at least one of the one or more computing devices to:
store data associated with a plurality of training programs within at least one data structure in a database;
receive a selection of at least one training program of the plurality of training programs;
track the at least one selected training program;
manage an interview for a user corresponding to the at least one selected training program; and
store revised data associated with the at least one selected training program within the at least one data structure based at least in part on the interview.

14. The at least one non-transitory computer-readable medium of claim 13, wherein the data includes data from at least one survey associated with ratings of training programs corresponding to a set of attributes or factors.

15. The at least one non-transitory computer-readable medium of claim 13, wherein the training programs are residency and fellowship training programs.

16. The at least one non-transitory computer-readable medium of claim 13, further storing computer-readable instructions that, when executed by one or more computing devices, cause at least one of the one or more computing devices to display ratings information associated with one or more of the plurality of training programs.

17. The at least one non-transitory computer-readable medium of claim 13, further storing computer-readable instructions that, when executed by one or more computing devices, cause at least one of the one or more computing devices to receive ratings information corresponding to an attribute associated with the selected training program.

18. The at least one non-transitory computer-readable medium of claim 17, further storing computer-readable instructions that, when executed by one or more computing devices, cause at least one of the one or more computing devices to calculate an overall rating for the selected training program based at least in part on the ratings information.
